(19) United States
(12) Patent Application Publication
(10) Pub. No.: US 2017/0328010 A1
(43) Pub. Date: Nov. 16, 2017

(54) HYGIENIC TISSUE

(71) Applicant: ReddyCare, LLC, Cincinnati, OH (US)

(72) Inventors: Sara Rani Reddy, Cincinnati, OH (US); Trisha Reddy, Cincinnati, OH (US); Usha P. Reddy, Cincinnati, OH (US)

(21) Appl. No.: 15/591,982

(22) Filed: May 10, 2017

Related U.S. Application Data
(60) Provisional application No. 62/423,657, filed on Nov. 17, 2016.
(60) Provisional application No. 62/333,942, filed on May 10, 2016.

(51) Int. Cl. D21H 27/00; A47K 7/03; A47L 13/19; B31D 1/04; B08B 1/00; A47K 10/32

(52) U.S. Cl. CPC D21H 27/007; B31D 1/04; B08B 1/006; A47K 7/03; A47L 13/19; A47K 2010/3266

(57) ABSTRACT

A hygienic tissue includes a front side and a back side. The front side includes an absorbent material and the back side includes an absorbent material. A fluid resistant material is between the front side absorbent material and the back side absorbent material, and a pocket is on the back side for receiving one or more of a user's fingers. The back side defines an aperture for providing access to the pocket. The aperture is surrounded on one or more sides by the back side such that one or more pockets are formed along the back side. Attachments can be used to attach the tissue to a user's hand, wrist or ears. The tissue can be used, for example, when sneezing, coughing, nose blowing or touching contaminated surfaces, as a hygienic tissue, face mask, and wet wipe.

### CROSS-REFERENCE TO RELATED APPLICATIONS

This application claims the benefit of U.S. Provisional Application No. 62/423,657, filed Nov. 17, 2016, and titled “HYGIENIC TISSUE,” and U.S. Provisional Application No. 62/333,942, filed May 10, 2016, and titled “PERSONAL HYGIENIC DEVICE.” Both of these prior applications are incorporated by reference in their entirety.

### FIELD OF THE INVENTION

The present disclosure is related to the field of personal hygienic tissues. More specifically, the present disclosure is related to a durable hygienic tissue configured to protect the hand and fingers from contamination and trap infectious agents.

### BACKGROUND OF THE INVENTION

When an individual is suffering from a cold or other viral or bacterial infection, a goal of personal care is to reduce or prevent further spread of the infectious agent. Coughing and sneezing can easily spread germs to people and surfaces surrounding the sick individual. Further, the individual may spread germs by coughing or sneezing into her own hand, and then touching objects around her. Use of traditional facial tissues with coughing and sneezing can reduce the exposure to surrounding people and surfaces, but is not without limitations. First, facial tissues are often thin and permit body exudates (e.g., nasal exudates or saliva) to soak through, such that the sick individual's hands or fingers may be contaminated with germ-containing fluids. Second, facial tissues are generally flat in shape and easily permit the user's fingers to contact the face or body exudates at the edges of the tissue. Then, if the user does not wash or sanitize her hands immediately after coughing or sneezing, she is at risk for spreading germs to people and/or fomites as she comes in contact with objects around her.

General infection control procedures have been in use for decades, but more attention has been paid to the respiratory droplet protection aspect in recent years with outbreaks of the Severe Acute Respiratory Syndrome (SARS), Avian Flu (H5N1) and most recently, Swine Influenza A (H1N1) virus. These acute respiratory infections (ARIs) are the leading cause of morbidity and mortality from infectious disease worldwide, particularly affecting the youngest and oldest members of our population. Although knowledge of transmission modes is ever-evolving, current evidence indicates that the primary mode of transmission of most ARIs is through droplets, contact (including hand contamination followed by self-inoculation) and infectious respiratory aerosols at short range with some pathogens in particular circumstances.

Early recognition of ARIs and infection prevention and control (IPC) measures, including respiratory and hand hygiene, are essential source controls aimed at reducing or preventing the dissemination of infectious agents from the source. There has been a good deal of confusion in the health care industry in regards to what is appropriate respiratory protection and product selection for IPC. The Center for Disease Control (CDC) has promoted the practice of covering the mouth and nose during coughing or sneezing using a medical mask, cloth mask, tissues, a sleeve or flexed elbow, followed by hand hygiene, to reduce the dispersal of respiratory secretions that may contain infectious particles.

Currently available disposable facial tissues have been somewhat standardized in that they are often made from the lowest basis weight (g/m²) layers of paper which after used to blow noses or contain a sneeze do not provide protection against hand contamination and often do not prevent infectious particles from entering the air surrounding the user.

Disposable face masks have been used in a variety of ways in today's workplaces and a new surge has been observed with application in personal protection, particularly in view of fears concerning spread of illness. Facial masks provide the wearer protection against upper respiratory ailments of the lungs, throat, and mouth, as well as a multitude of other airborne illnesses. Currently available disposable facial masks are cumbersome to wear and, although acceptable in some countries and regions, may be considered socially unacceptable or an unnecessary burden in other regions.

Thus, a need exists for improved personal protection for facial tissue and both wet and dry wipes that is configured to reduce contamination and the spread of infectious agents through air and surface contact.

### SUMMARY OF THE INVENTION

Described herein is a hygienic tissue having the filtering benefits of a face mask and the convenience of a facial tissue, with the added benefit of protecting a user's hand from contamination. The hygienic tissue is configured to reduce contamination from infectious agents. The hygienic tissue has a safety advantage with applications in the health care, medical, daycare, nursing home, education, and general workplaces, as well as general home and personal use.

Historically, facial tissues have been made with low basis weight cellulose derived fibers with little attention paid to the need for such a product to prevent the spread of germs and other infectious agents. Current facial tissue products fall short of the growing expectations of consumers to have convenient and effective means of illness prevention. Wearing a medical or cloth mask can be burdensome to the wearer and become ineffective if a wearer does not cover their nose properly. The use of a sleeve or flexed elbow is also flawed in providing effective infection control due to variation in technique that may leave the mouth or nose exposed while sneezing or coughing. In addition, this method renders the sleeve or elbow possibly contaminated with infectious droplets where pathogens can survive for hours. A wide range of techniques and varying degrees of effectiveness leave a critical need for new, effective, and easy to implement infection control products.

Current facial tissues on the market have an inherent breathability due to their construction from thin, lowest basis weight pulp products that make them effective in wiping secretions due to rhinorrhea, but during conventional use they do very little in containing pathogens from entering the air. Conventional facial tissues also have a hazard of hand contamination after use that may cause a user to spread pathogens onto other surfaces, such as human contact, door-knobs and common household and office items. The general population would benefit from convenient hygienic tissue products with the benefits of face masks and gloves that are as easy to use as facial tissue when coughing or sneezing.

Furthermore, hand contamination during the execution of common tasks may be avoided allowing the user to continue the task without fear of spreading germs or soiling other areas that they may touch. Common hand gloves are cumbersome and require two hands to put on properly.

A technical measure of infection control products is bacterial filtration efficiency (BFE) which is measured by the Bacterial Filtration Efficiency Test Method to determine percent efficiency at which an infection control product filters bacteria passing through the product. Another technical measure of infection control products is particle filtration efficiency (PFE) which is measured by the Particle Filtration Efficiency Test Method to determine the percent efficiency at which an infection control product filters particulate matter passing through the product. A technical measure of fluid resistance is evidenced by the Synthetic Blood Penetration—Liquid Barrier Test Method or Synthetic Blood Penetration- Splash Resistant Test Method to determine the ability of an infection control product to minimize fluids from traveling through the material and potentially coming into contact with the user. Fluid resistance helps to reduce potential exposure to body fluids. Current facial tissue products fall short of expectations of infection control necessary in this current climate of rapid spreading acute respiratory illnesses. Hygienic tissues products that exhibit these properties assist in decreasing the risk of infectious airborne contaminants or surface contaminants.

A hygienic tissue product that exhibits substantial BFE properties, substantial PFE properties, and substantial fluid resistance properties provides consumers with hygienic tissue products that fulfill the need for effective infection control. According to one aspect, a hygienic tissue product with filtering properties includes one or more planar layers of nonwoven or woven material that exhibit a novel combination of bacterial filtration efficiency (BFE) as evidenced by the Bacterial Filtration Efficiency Test Method of the hygienic tissue products, particle filtration efficiency (PFE) as evidenced by Particle Filtration Efficiency Test Method of the hygienic tissue products, and the fluid resistance as evidenced by the Synthetic Blood Penetration—Liquid Barrier Test Method of the hygienic tissue products.

For example, a hygienic tissue exhibits bacterial filtration efficiency performance that is greater than or equal to 95% or greater than or equal to 98% or greater than or equal to 99% as measured according to the Bacterial Filtration Efficiency Test Method; and/or particulate filtration efficiency performance that is greater than or equal to 95% at 0.1 micron or greater than or equal to 98% at 0.1 micron or greater than or equal to 99% at 0.1 micron as measured according the Particle Filtration Efficiency Test Method; and/or fluid resistance to penetration of synthetic blood at a velocity of greater than or equal to 80 mmHg or greater than or equal to 120 mmHg or greater than or equal to 160 mmHg as measured according to the Synthetic Blood Penetration—Liquid Barrier Test Method or Synthetic Blood Penetration—Splash Resistant Test Method. The hygienic tissue product may also exhibit breathability.

According to one aspect, a hygienic tissue includes a front side and a back side. The front side includes an absorbent material and the back side includes an absorbent material. The hygienic tissue includes a fluid resistant material between the front side absorbent material and the back side absorbent material, and a pocket on the back side for receiving one or more of a user's fingers.

Embodiments of this aspect may include one or more of the following features.

The front side includes a layer of absorbent material. The back side includes a layer of absorbent material. The fluid resistant material includes a layer of fluid resistant material between the front side layer and the back side layer. The back side layer defines an aperture for providing access to the pocket. The front side layer, the fluid resistant layer, and the back side layer are separate sheets that are joined, for example, by embossing or lamination. The layers are joined along their outer edge regions.

The aperture is surrounded on four sides by the back side layer such that pockets are formed along an entire circumference of the back side. In an illustrated example, at least one section of the tissue is folded back to form the pocket. Four sections of the tissue are folded back to form pockets. The hygienic tissue includes four outer edge regions and at least one edge region includes an open portion. At least one of the materials comprises a three dimensional patterned material.

The hygienic tissue has a bacterial filtration efficiency performance of at least 95%, at least 98%, at least 99% as measured according to the Bacterial Filtration Efficiency Test Method. The hygienic tissue has a particulate filtration efficiency performance of at least 95%, at least 98%, at least 99% at 0.1 micron as measured according the Particle Filtration Efficiency Test Method. The hygienic tissue has a fluid resistance to penetration of synthetic blood at a velocity of at least 80 mmHg, at least 120 mmHg, at least 160 mmHg as measured according to the Synthetic Blood Penetration—Liquid Barrier Test Method or Synthetic Blood Penetration—Splash Resistant Test Method.

The various embodiments of the hygienic tissue described above can be infused with a liquid composition to form a wet wipe. Wet wipes may be used to wipe surfaces, for example, in cleansing hard surfaces, food, inanimate objects, toys and body parts including the face. In particular, they may be used on the perianal area after defecation. They may also be used to remove make-up or apply lotion on the body.

The wet wipe is typically packaged in a moisture impervious container and/or wrapper. Multiple tissues can be stored in a container containing the liquid and can be pulled out individually for use as a wet wipe. In another example of the present invention the surface of the wet wipe may optionally contain raised and/or lowered portions. These can be in the form of logos, indicia, trademarks, geometric patterns, images of the surfaces. In another example of the present invention the wet wipe may be biodegradable and or dispersible. For example, the wet wipe could be made from a biodegradable material such as a polyesteramide, or high wet strength cellulose.

According to another aspect, a hygienic tissue includes a front side and a back side. The front side includes an absorbent material. A fluid resistant material is behind the absorbent material. Pockets are along an entire circumference of the back side for receiving one or more of a user's fingers.

Embodiments of this aspect may include one or more of the following features. The front side includes a layer of absorbent material. The back side includes a layer of absorbent material. The fluid resistant material includes a layer of fluid resistant material. The back side layer defines an aperture for providing access to the pockets. The front side layer, the fluid resistant layer, and the back side layer are separate sheets joined, for example, along their outer edge regions by, for example, embossing or lamination. One or more, for example, four sections, of the tissue are folded back to form the pockets.

According to another aspect, a system includes a tissue having a front side and a back side, the front side including an absorbent material, a fluid resistant material behind the absorbent material, and a pocket on the back side for receiving a user's fingers. The system includes left and right ear attachments extendable from the tissue such that the tissue is positionable over the user's face and attached to the ears. In particular embodiments, the attachments can be attachable and detachable from the tissue for reuse of the attachments.

According to another aspect, a system includes a tissue having a front side and a back side, the front side including an absorbent material, a fluid resistant material behind the absorbent material, and a pocket on the back side for receiving a user's fingers. The system includes an attachment, for example, one or two attachment loops, extendable from the tissue. In particular embodiments, the attachment can be attachable and detachable from the tissue for reuse of the attachment.

According to another aspect, a method of using a hygienic tissue includes positioning one or more fingers into a pocket on a back side of the tissue, the tissue having a front side and the back side, the front side including an absorbent material, the tissue including a fluid resistant material behind the absorbent material; and placing the tissue over a mouth and/or nose using the fingers positioned in the pocket when sneezing, coughing, nose blowing, or when in an area of air contamination.

According to another aspect, a method of using a hygienic tissue includes positioning one or more fingers into a pocket on a back side of the tissue, the tissue having a front side and the back side, the front side including an absorbent material, the tissue including a fluid resistant material behind the absorbent material; and using the tissue to touch surfaces that may be contaminated to shield hands and fingers from getting contaminated.

According to another aspect, a method of using a hygienic tissue includes placing the tissue over a user's mouth and/or nose, the tissue having a front side and a back side, the front side including an absorbent material, the tissue including a fluid resistant material behind the absorbent material and a pocket on the back side for receiving one or more of a user's fingers; and securing the tissue to the user's ears.

According to another aspect, a method of using a hygienic tissue includes placing the tissue over a user's mouth and/or nose, the tissue having a front side and a back side, the front side including an absorbent material, the tissue including a fluid resistant material behind the absorbent material and a pocket on the back side for receiving one or more of a user's fingers; and securing the tissue to the user's hands or wrist.

According to another aspect, a method of using a hygienic tissue infused with liquid includes wiping a surface with the tissue, the tissue having a front side and a back side, the front side including an absorbent material, the tissue including a fluid resistant material behind the absorbent material and a pocket on the back side for receiving one or more of a user's fingers.

In another embodiment, a hygienic tissue includes a front sheet and a back sheet formed from a single sheet that is folded to provide the front sheet and the back sheet connected along a folded top edge. The front sheet and the back sheet are joined along each side edge to form a pocket. The front sheet is longer than the back sheet, such that the bottom edge of the front sheet extends beyond the bottom edge of the back sheet. In particular embodiments, the bottom edge of the back sheet may have punched out shapes to facilitate a one handed application by the user.

In another embodiment, a hygienic tissue includes a front sheet; and a back sheet defining an aperture for inserting at least a portion of the hand or fingers of a user. The front sheet and the back sheet are joined along the outside edges such that a continuous pocket is formed along the outside edges of the hygienic tissue.

In another embodiment, a hygienic tissue includes a front sheet and a back sheet formed from a single sheet that is folded to provide the front sheet and the back sheet connected along a folded top edge. The back sheet defines an aperture for inserting at least a portion of the hand or fingers of a user. The front sheet and the back sheet are joined along each side edge such that a continuous pocket is formed along the outside edges of the hygienic tissue.

According to aspects of the hygienic tissue, the hygienic tissue is a facial tissue that is disposable and more durable than currently available facial tissues. The hygienic tissue has filtering properties that reduce or prevent the spread of germs via airborne and direct contact means.

According to another aspect, the hygienic tissue is a tissue comprised of two joined sheets, wherein the joined sheets form a pocket that permits the user to tuck at least a portion of the hand and/or fingers inside the pocket, thereby protecting the hand and/or fingers from direct contact with body exudates upon use. In this way, the user is free to touch surrounding objects after coughing, sneezing or nose blowing, without the risk of spreading infectious agents through direct contact. The hygienic tissue may comprise pockets on each edge or on 1, 2, 3, or more edges of the tissue. The pockets are oriented to the back of the tissue, such that the tissue drapes over the user's hand and/or fingers to minimize contamination to the same. In one embodiment, each outside edge of the front and back sheet is fused and an aperture is present in the back sheet, such that a continuous pocket is formed along all outside edges of the back sheet of the hygienic tissue. The user can then insert at least a portion of the hand and/or fingers through the aperture in the back sheet and into a pocket.

In another embodiment, a hygienic tissue includes a front sheet having top, bottom, and side edges; and a back sheet having top, bottom, and side edges. The front sheet is longer than the back sheet such that the when the top edges of the front sheet and the back sheet are aligned, the bottom edge of the front sheet extends beyond the bottom edge of the back sheet, and the front sheet and the back sheet are joined along the top and side edges to form a pocket.

The hygienic tissue described herein requires less material and can be more easily slipped over the fingers of a user without two-handed effort as compared to a mitt or glove. That is, the shorter back sheet of the hygienic tissue disclosed herein permits a user to separate the layers of material and easily insert fingers into the pocket, thereby protecting the hand and/or fingers from contamination.

In some embodiments, the hygienic tissue includes a front sheet and a back sheet. Each sheet is formed of a single layer of a woven or nonwoven material or a paper or cellulose-derived material. In another embodiment, the hygienic tissue includes a front sheet and a back sheet. Each sheet is formed of a single layer or multiple layers of a woven or nonwoven material or a paper or cellulose-derived material that provide filtration properties to the hygienic tissue, for example SMS (spunbond, meltblown, spunbond) or MSM (meltblown, spunbone, meltblown) material. In certain embodiments, the multiple layers are two or more layers, and each layer is independently selected from a woven material, a nonwoven material, a paper material, and a cellulose-derived material. Optionally, the hygienic tissue is formed of a soft, absorbent material that provides filtration properties to prevent infectious agents from seeping through the tissue and contacting the hand and/or fingers of the user.

The hygienic tissue can be a facial tissue or a facial tissue that can be converted to a wearable face mask. In one embodiment, the hygienic tissue is a facial tissue that can be converted to a face mask using one or more fasteners, such as loops, tie strips, clips, or elastic loops, such that the tissue can be placed over the face or ears of the user, or on a user's wrist to conveniently hold the tissue.

In certain embodiments, the hygienic tissue includes at least one fastener for securing the hygienic tissue to a body of a user. Optionally, the at least one fastener is a loop or tie attached to the hygienic tissue by an attachment, for example, adhesive, hook and loop, ties, clips, grippers, and combinations thereof.

In some embodiments, the hygienic tissue is disposable and intended for single use and is constructed from a nonwoven material. In other embodiments, the hygienic tissue is reusable and is constructed from a woven and/or nonwoven material.

A hygienic tissue of the present disclosure minimizes or prevents the airborne spread of infectious agents and minimizes or prevents hand contamination from coughing, sneezing or nose blowing. In some embodiments, a healthy individual can wear a hygienic tissue as disclosed herein over her mouth or nose to avoid exposure to infectious agents.

Front and back sheets of material may be joined by sewing, gluing, heating or ultrasonic welding. Methods of bonding may include but are not limited to hot calendaring, belt calendaring, through-air thermal bonding, ultrasonic bonding, and radiant-heat bonding.

In certain embodiments, each of the front sheet and the back sheet is formed from one or more layers. In a specific embodiment, the one or more layers are made from woven material, nonwoven material, paper material, cellulose-derived material, or combinations thereof.

In some embodiments, the hygienic tissue forms a filter for trapping infectious agents.

In some embodiments, the hygienic tissue further has a static charge.

An assembly includes a dispenser and a plurality of hygienic tissues as described herein, housed within the dispenser. In some embodiments, the dispenser imparts a static charge to a surface of a hygienic tissue.

Also provided is a kit including a hygienic tissue as described herein; and at least one separately provided fastener having an attachment, for example, adhesive, hook and loop, ties, grippers, and combinations thereof.

In some embodiments, the hygienic tissue described herein includes front and back sheets and each sheet has two or more layers. Each of the layers is independently selected from a woven material, a nonwoven material, a paper material, a cellulose-derived material, and combinations thereof.

A hygienic tissue can have a front sheet and a back sheet formed from a single sheet that is folded to provide the front sheet and the back sheet connected along a folded top edge. The front sheet and the back sheet are secured along each side of the fold to form a pocket. The front sheet is, for example, longer than the back sheet such that the bottom edge of the front sheet extends beyond the bottom edge of the back sheet. The back sheet may have elongated sides for covering the fingers and/or thumbs.

According to another aspect, a method of making tissue includes punching shapes in flat fabric, forming the fabric into a tube shape, sealing the tube shape, and cutting and sealing cuts to form the tissue.

Embodiments of this aspect may include one or more of the following features. The tube shape is flattened before being cut, and the cuts in the flattened tube are sealed. The shapes are punched before the tube shape is formed. Alternatively, the shapes are punched after the tube shape is formed.

According to another aspect, a method of making tissue includes punching shapes in flat fabric, folding the flat fabric, cutting the folded flat fabric, and sealing cuts in the folded flat fabric.

Embodiments of this aspect may include one or more of the following features. The shapes are punched before folding the flat fabric. The method includes sealing the folded flat fabric. The fabric is folded along a midline of the fabric. Alternatively, the fabric is folded along an axis that is not a midline of the fabric.

These and other objects, features, embodiments, and advantages will become apparent to those of ordinary skill in the art from a reading of the following detailed description and the appended claims.

### BRIEF DESCRIPTION OF THE DRAWINGS

The following detailed description of specific embodiments can be best understood when read in conjunction with the following drawings:

FIGS. 1A-1D are front, back, side and perspective views, respectively, of an embodiment of a hygienic tissue showing a pocket on the back side in which a user's hand is inserted.

FIGS. 2A and 2B are cross-sectional and perspective views, respectively, of another embodiment of a hygienic tissue.

FIGS. 2C and 2D illustrates the hygienic tissue of FIGS. 2A and 2B prior to and after folding, respectively.

FIGS. 3A-3D, 4, 5A and 5B illustrate additional alternative embodiments of a hygienic tissue.

FIG. 6 illustrates a process of forming a hygienic tissue.

FIGS. 7A and 7B are side views of a hygienic tissue dispenser and FIG. 7C is a top view of the dispenser.

FIG. 8A illustrates a hygienic tissue and attachable fastener; FIG. 8B illustrates a hygienic tissue with two attached fasteners; and FIG. 8C illustrates a hygienic tissue with one attached fastener.

FIGS. 9A and 9I illustrate folding a fabric to form hygienic tissue and FIGS. 9B-9H illustrate various configurations of hygienic tissue formed by folding a fabric.

FIGS. 10A-10D illustrate forming hygienic tissue using a tube forming process and FIG. 10E illustrates alternative shapes punched in the fabric.

FIG. 11 illustrates an alternative folding method for forming hygienic tissue.

FIGS. 12A-12E illustrate an alternative tube forming process for forming hygienic tissue.

### DETAILED DESCRIPTION OF THE INVENTION

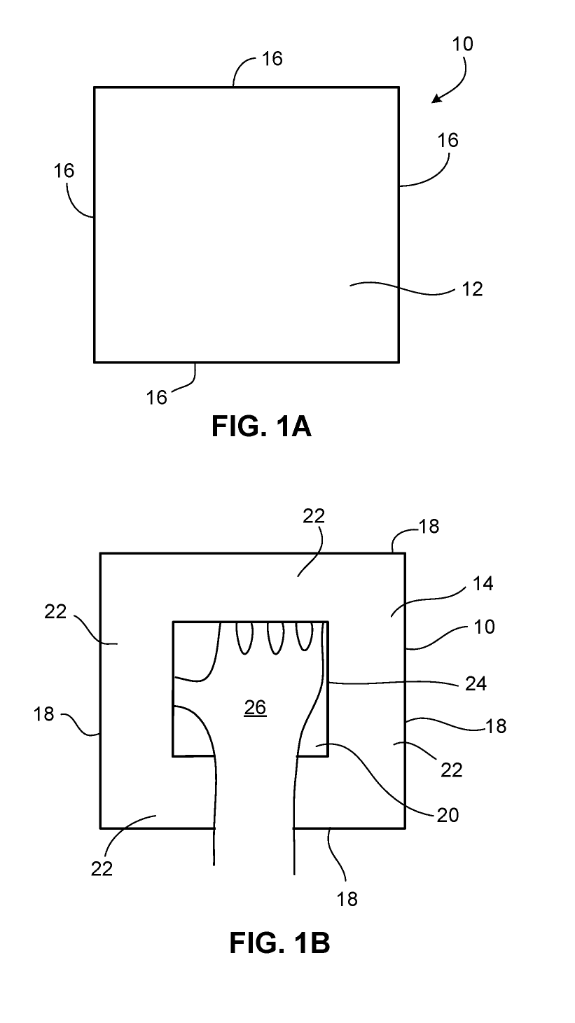

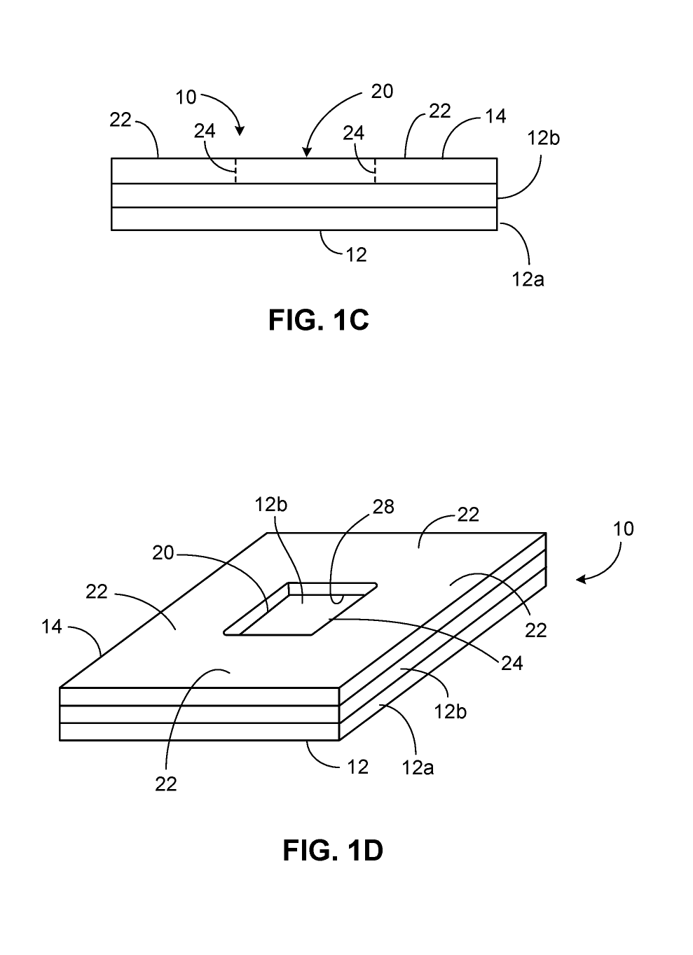

Referring to FIGS. 1A-1D, a hygienic tissue 10 includes a front sheet 12 at a front side of the tissue, and a back sheet 14 at a back side of the tissue. The front sheet 12 includes a front side absorbent material with a fluid resistant material behind the absorbent material, for example, the front sheet 12 is a multi-layer sheet having a layer 12a of absorbent material such as cellulose derived material, for example, viscose, rayon, cotton, flax and/or bamboo, and a layer 12b of fluid resistant material such as polypropylene, polyurethane, polyethylene, and/or polyactide. The back sheet 14 includes at least an absorbent material, for example, a layer of absorbent material. The back sheet can include an additional layer of fluid resistant material located, for example, in front of the layer of absorbent material of the back sheet.

The front and back sheets 12, 14 are secured along all four of their outside edge regions 16, 18, respectively. The back sheet 14 defines an aperture 20 such that pockets 22 are formed along the entire circumference of the tissue 10. The pockets 22 are defined by the front and back sheets 12, 14 and extend from inner edges 24 of the back sheet 14 to the joined outside edge regions 16, 18. The outside edge regions 16, 18 can be joined along their outer edges, can be joined along regions extending inward from their outer edges, or can be joined along regions spaced from their other edges. The pockets 22 allow a person to tuck at least a portion of her hand and/or fingers 26 inside through the aperture 20 of the back sheet 14 and into the space 28 between the front and back sheets defined by the pockets 22.

While square-shaped sheets are illustrated, the sheets may be the same shape or differently shaped, and may be other rectangle shapes, circular, polygonal, or other geometric shapes.

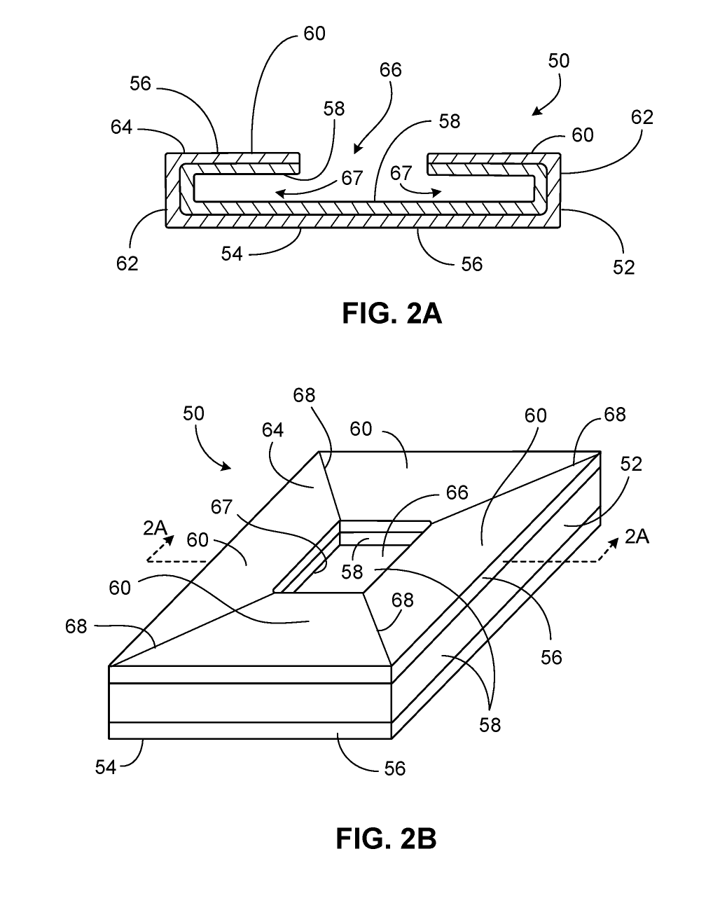

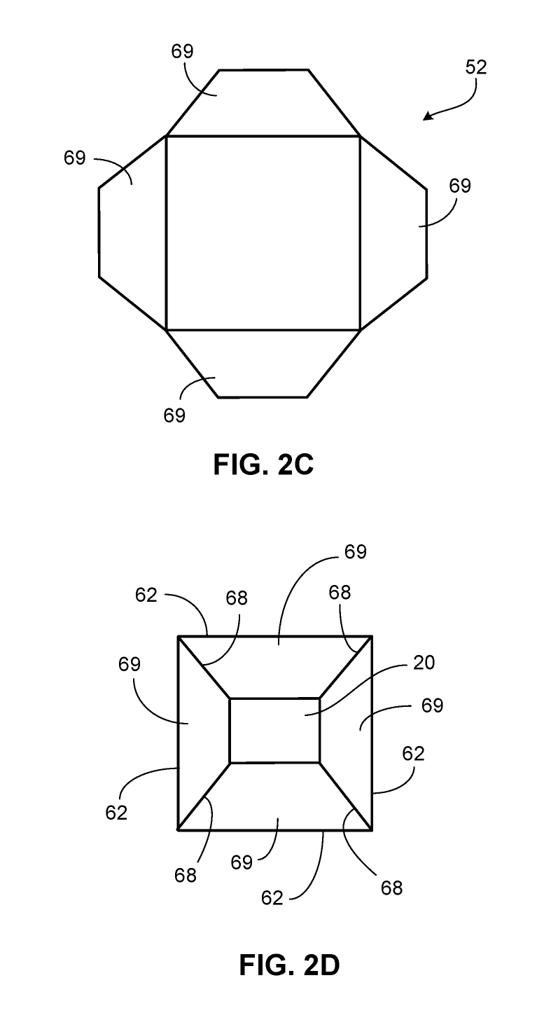

Referring to FIGS. 2A and 2B, in an alternative embodiment, rather than forming the tissue from separate front and back sheets that are joined, a tissue 50 is formed from a single, planar, multi-layer sheet 52. The sheet 52 has a front side 54 formed by a layer 56 of absorbent material with a layer 58 of fluid resistant material behind the layer 56. Pockets 60 are formed along the entire circumference of the tissue 50 by folding four circumferential sections 69 of the sheet over forming four folded edges 62. The folding of the sheet 52 forms a back side sheet 64 of the tissue 50 having an aperture 66 for introducing fingers into the pockets 60. The back sheet is secured, for example, by bonding, along four bond lines 68 to maintain the shape of the folded sheet forming the pockets 60. As illustrated in FIGS. 2C and 2D, prior to folding the sheet 52, the sheet 52 can be cut to shape to create the four sections 69 that when folded back overlap enough such that the four bond lines 68 can be bonded.

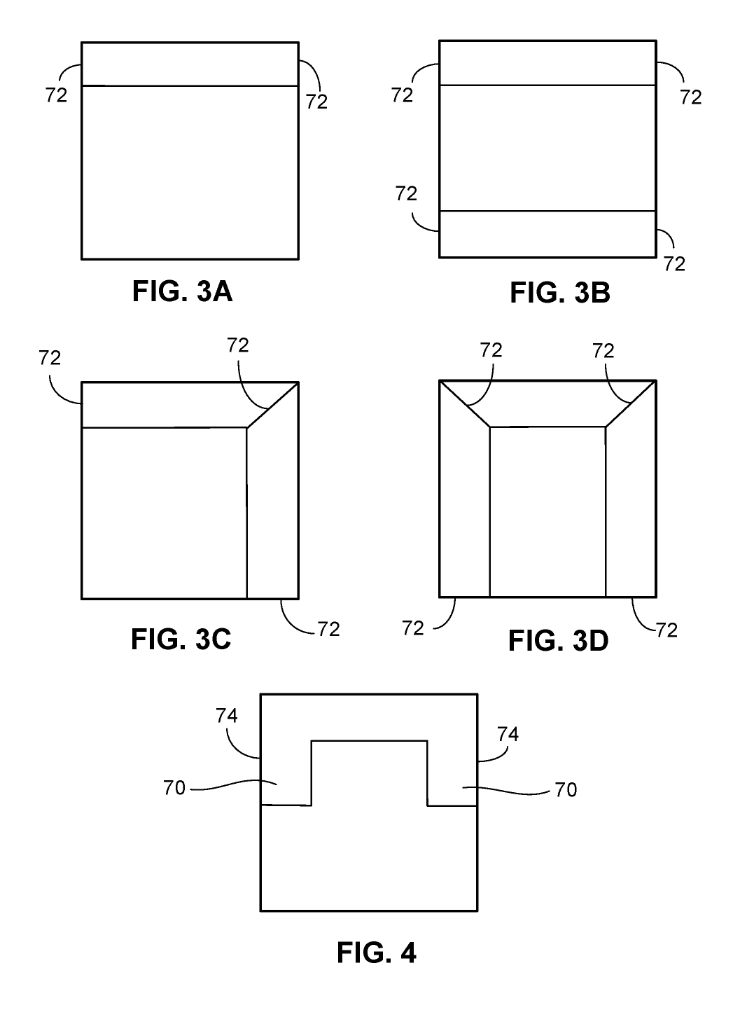

The tissue may have all four edges folded, or 1, 2, or 3 edges folded, as illustrated in FIGS. 3A-3D, such that at least one edge region includes an open portion. Optionally, the sides 70 of a single folded edge are elongated, as illustrated in FIG. 4, to cover the thumbs and fingers of a user. The folded edges of FIGS. 3A-3D are sealed along 72 to form pockets. The folded edge of FIG. 4 is sealed along 74 to form pockets.

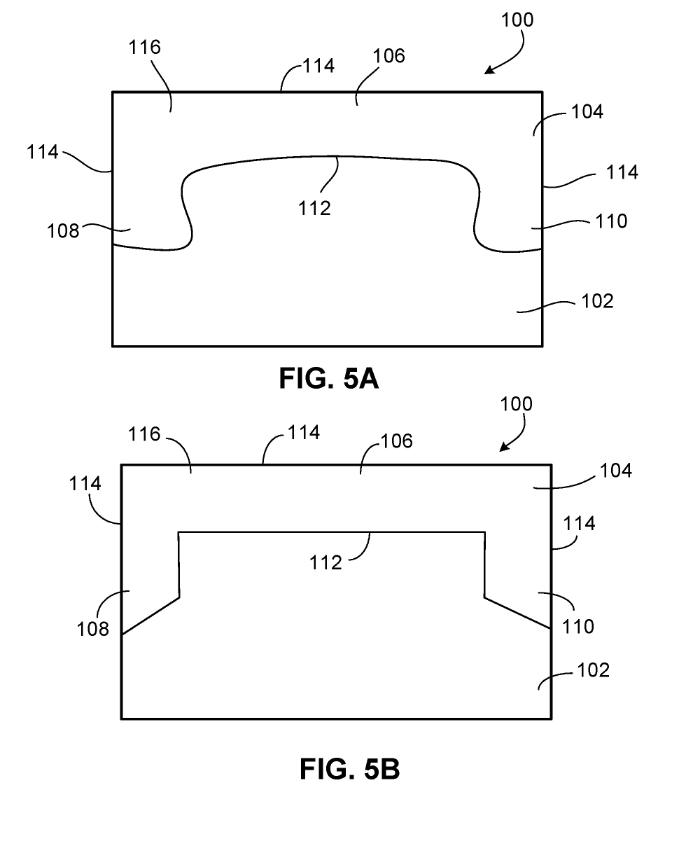

Referring to FIG. 5A, a tissue 100 includes a front sheet 102 and a back sheet 104, as in the embodiment of FIG. 1D, with the back sheet 104 being shorter than the front sheet 102. The back sheet 104 has a top portion 106 and side portions 108, 110 for covering the fingers. The back sheet 104 can have, for example, a curved contour along a bottom edge 112, as illustrated in FIG. 5A, or an angular contour along the bottom edge 112, as illustrated in FIG. 5B. The front and back sheets 102, 104 are joined along the edge regions 114 to form pocket 116. Because the back sheet is shorter than the front sheet, at least one edge region includes an open portion and a user can easily separate the sheets of material in order to slip the hand/fingers inside the pocket 116.

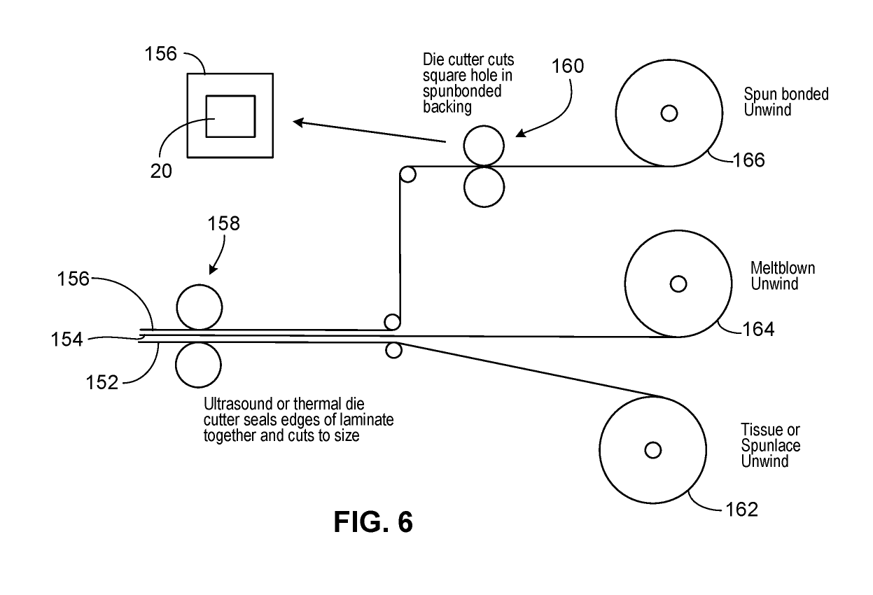

Rather than joining a back sheet to a multi-layer front sheet, as illustrated in FIG. 1, the tissue 10 can be formed by joining three separate sheets. As illustrated in FIG. 6, the tissue 10 is formed from a front sheet 152 of absorbent material, a middle sheet 154 of fluid resistant material, and a back sheet 156 of absorbent material. Prior to joining the three sheets at 158, the back sheet 156 is die cut at 160 to form the aperture 20. The three sheets are joined at 158 by, for example, an ultrasonic or thermal die cutter that seals the edge regions of the sheets together and cuts the tissue to size. For example, front sheet 152 can be unwound from a tissue or spunlace unwind 162; middle sheet 154 can be unwound from a meltblown unwind 164; and back sheet 156 can be unwound from a spunbonded unwind 166.

Joining and/or securing of front and back sheets is accomplished through various methods known in the art. For example, compiled sheets of nonwoven, woven, paper, cellulose-derived, or cotton-derived material may be joined by sewing, gluing, heating, and/or ultrasonic welding. Methods of bonding may include but are not limited to hot calendaring, belt calendaring, through-air thermal bonding, ultrasonic bonding, and/or radiant-heat bonding.

Woven materials are materials manufactured by holding fibers and/or yarns together by spinning and/or weaving. The fibers may be derived from a variety of base materials, including cotton, polyester, and/or viscose/Tencel. Weaving includes carding or combing fibers into one direction. The aligned fibers are then twisted or spun together to make a long continuous yarn, which is woven on a loom into a sheet, wherein yarns interlock to create strength.

Nonwoven materials are produced and held together by a method other than weaving. Fibers can be formed into a sheet using carding technology, wet forming technology, or air forming technology. The fibers are then locked in place to create strength using a variety of methods, including resin or chemical bonding, mechanical entanglement (e.g., hydroentangling with high pressure water jets or needle punching), thermal fusing (melting fibers together), and hydrogen bonding (e.g., ionic bonding between hydrogen and hydrozyl groups on the surface of cellulose). Base materials include, but are not limited to, polyester, viscose, Tencel, polypropylene, polyethylene, cotton, and/or wood pulp.

Paper materials are produced by mixing wood pulp fibers into a slurry with water. The slurry is poured onto a moving wire and the water is vacuumed off and dried. Hydrogen bonding, mechanical entanglement, and use of wet strength resin hold the web together to give the sheet strength.

Cellulose-derived materials originate from plant sources. The most common sources include wood pulp (derived from trees), viscose (fiber made by chemically dissolving and re-extruding the cellulose material into long fibers), Tencel, cotton, flax, and bamboo. Cellulose-derived materials have a surface chemistry that allows them to absorb and hold on to water better than synthetic or petroleum-based materials. Cellulosic materials will also biodegrade over time.

In certain embodiments, the hygienic tissue has one or more sheets that have a three dimensional patterned fusion of material forming a rippled, creped or quilted texture.

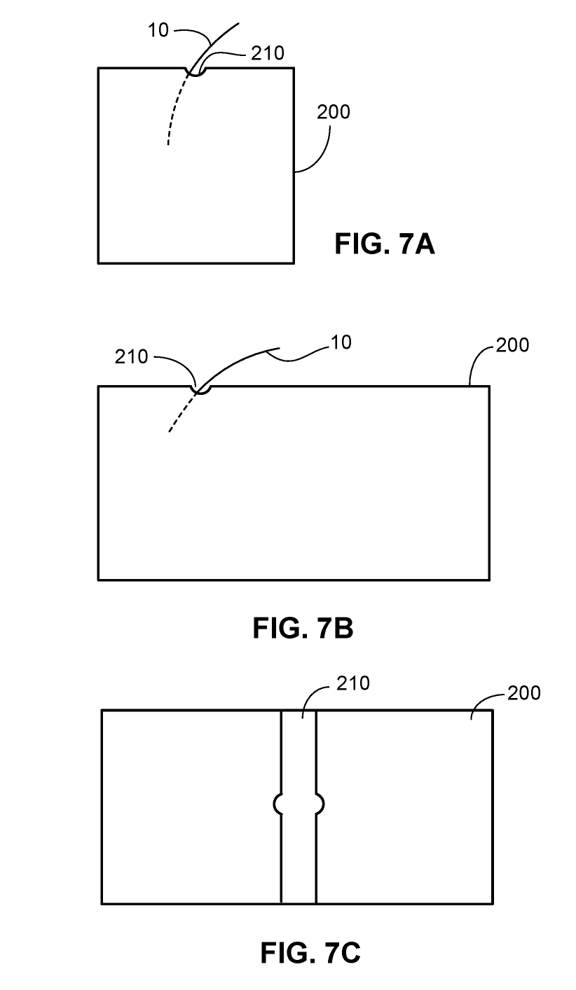

FIGS. 7A and 7B show two embodiments of a dispenser 200 that stores a plurality of tissues according to any of the embodiments described above, packaged for easy removal. Fig. 7C is a top view of the embodiment of FIG. 7B. The dispenser can alternatively be configured for convenient portability in a purse, pocket, etc.

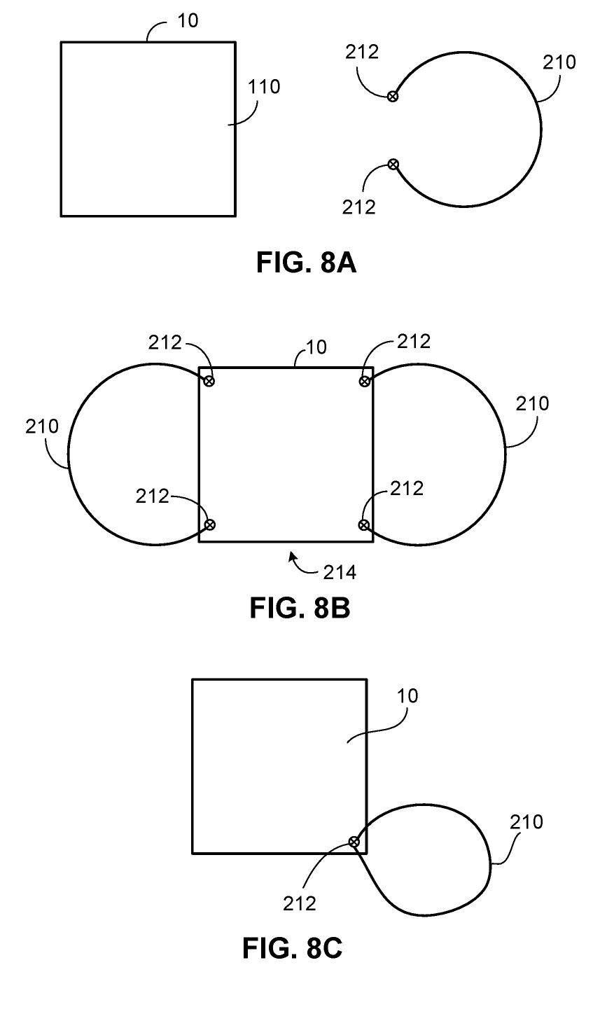

Optionally, the tissue according to any of the embodiments described above can be used with one or more fasteners, such as a clip, tie or loop, for attaching the tissue to the body of the user. The ties or loops can be formed from a variety of materials, including woven, nonwoven, paper, cellulose-derived, cotton-derived, elastic, and the like. For example, the fastener can be one or more elastic loops. Referring to FIG. 8A, a linear elastic loop 210 is attachable to a tissue 10. The elastic loop 210 includes attachments 212 for attaching the loop 210 to the tissue 10, for example, close to the edge 110. The attachments 212 can be adhesives, loop and hook closures, clips, ties, and/or grippers and the like.

As illustrated in FIG. 8B, elastic loops 210 are attached via attachments 212 to either side of the tissue 10 to provide an easily assembled face mask 214. A face mask frees the hands of the user, particularly if it is necessary to use the hygienic tissue for prolonged periods of time. As illustrated in FIG. 8C, an elastic loop 210 is attached at a corner of the tissue 10. Elastic loop(s) 210 can be attached to the tissue in any number of configurations, such that the tissue can be conveniently attached to the hand, body, or face of a user or to a purse or bag. A user may attach one loop, such that the tissue can be easily attached to the wrist or hand, or a user may 4attach two loops, such that the tissue can be converted to a face mask and worn on the face, with the loops hooking behind the ears of the user.

The various embodiments of the hygienic tissue described above can be infused with a liquid composition, for example to form a wet wipe. Liquid composition as used herein means any liquid including, but not limited to a pure liquid such as water, an aqueous composition, a colloid, an emulsion, a suspension, a solution and mixtures thereof. The liquid composition may be added to the hygienic tissue to form a wet wipe prior to and/or after packaging and/or prior to and/or after folding, if any, and/or prior to and/or after any post processing operation, such as embossing, tuft generating, and printing. The liquid composition may comprise water, alcohol, natural fats or oil emulsion, sterol or sterol derivative, fat-soluble vitamins such as vitamin E, emulsifying surfactant or cosurfactants, humectants, chelating agents, buffers, solvents, thickeners, dyes, colorants, lotions, biocides, fragrances, defoamers, pertrolatum, mineral oil, emulsifying wax and mixture thereof. Liquid composition may also comprise hydrophilic polymers selected from the group consisting of polysaccharides, polycarboxylates, polyvinyl alcohols, polyvinylpyrrolidones, polyethylene glycols, methylvinyl ethers, and mixtures thereof.

Multiple tissues can be stored in a container containing the liquid and can be pulled out individually for use as a wet wipe used in cleansing hard surfaces, food, inanimate objects, toys and body parts including the face. In particular, they may be used on the perianal area after defecation. They may also be used to remove make-up or apply lotion on the body.

Rather than forming the hygienic tissue of separate sheets that are joined, the hygienic tissue can be formed from a single sheet of fabric having a front side including an absorbent material, a back side including an absorbent material, and a fluid resistant material between the front side and the back side. The single sheet of fabric can include a layer of absorbent material at the front side, a layer of absorbent material at the back side, and a layer of fluid resistant material at the back side in the form of, for example, SMS (spunbond, meltblown, spunbond) or MSM (meltblown, spunbone, meltblown) material.

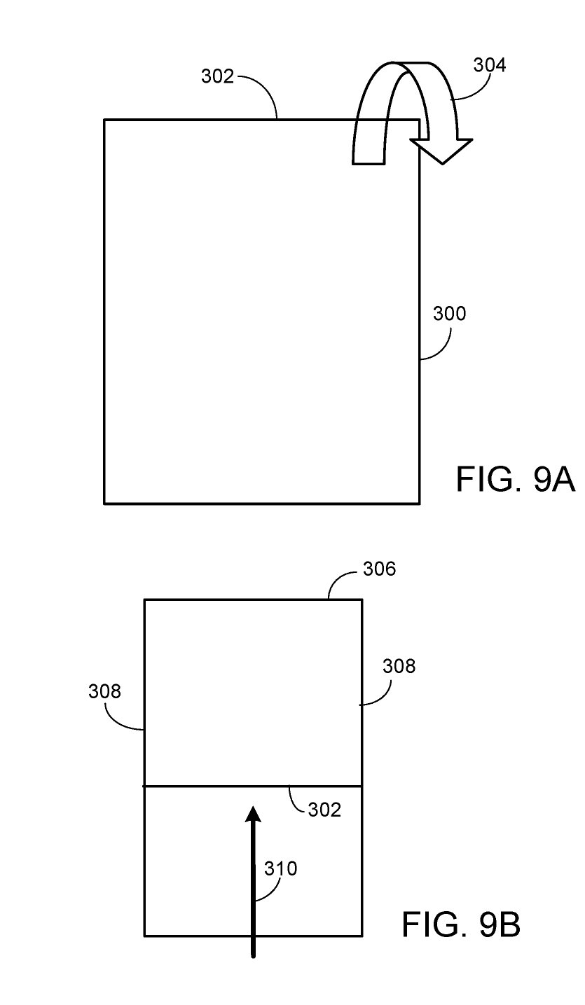

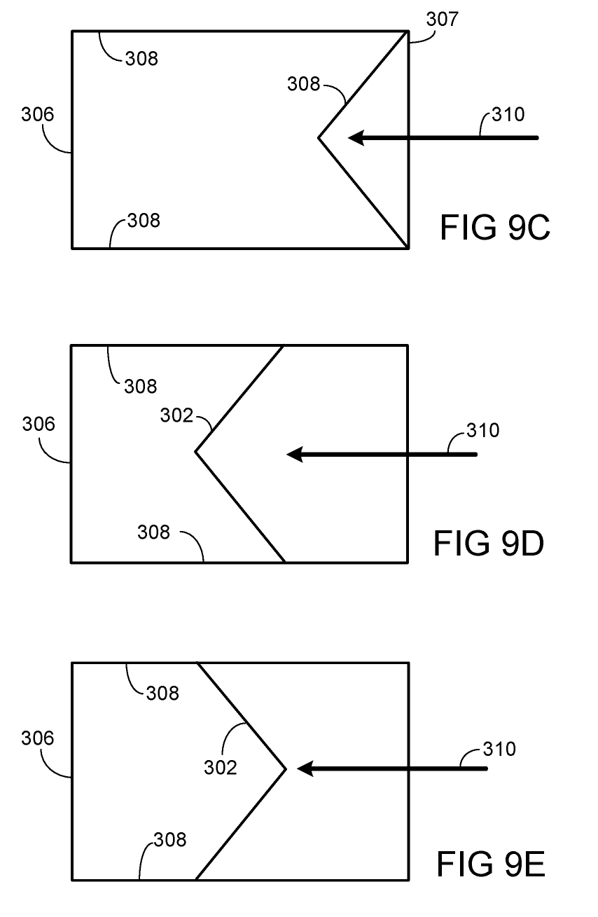

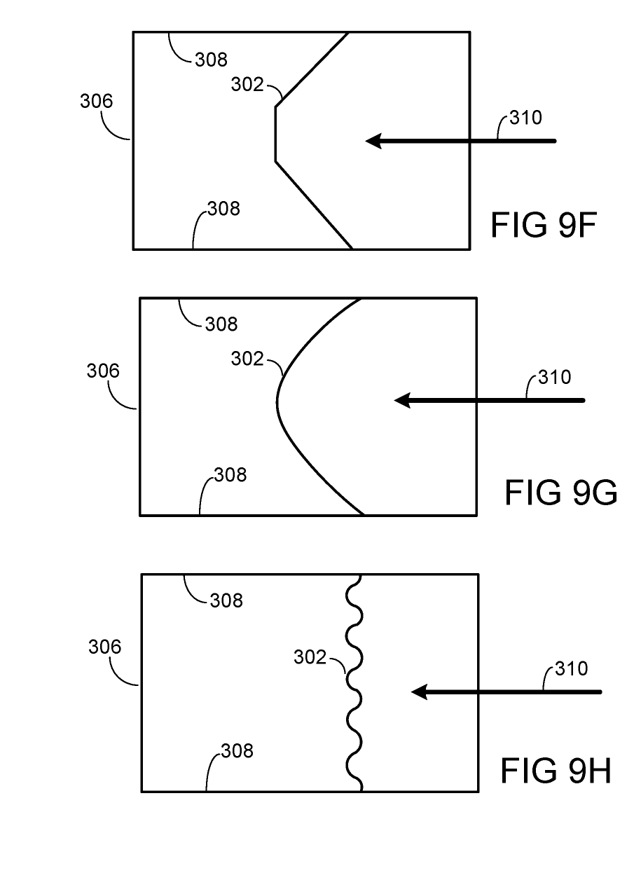

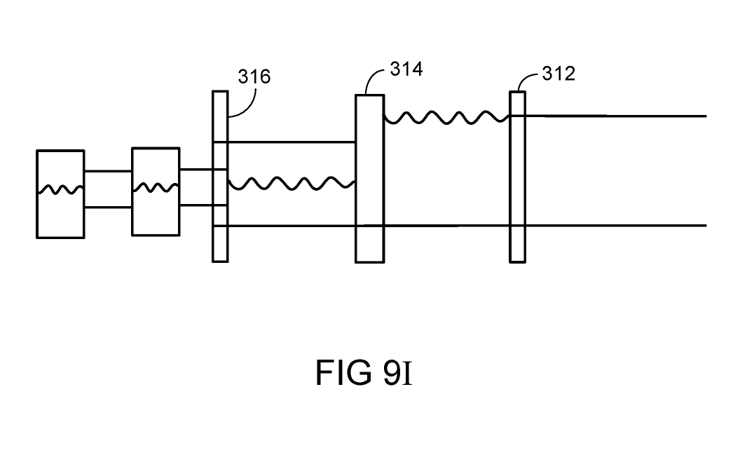

Additional manufacturing processes for making the hygienic tissue from separate sheets that have been joined or from a single sheet of fabric are illustrated in FIGS. 9-12. For example, referring to FIGS. 9A and 9B, to manufacture a tissue such as shown in FIGS. 3A and 9B, a top edge 302 of a length of flat fabric 300 is folded over, arrow 304, for example, along an axis that is not the midline of the fabric, to create a folded edge 306. The sides 308 of the tissue between the folded edge 306 and the top edge 302 are then sealed to form the pocket 310. The various configurations of the tissue shown in FIGS. 9C-9H can be formed by trimming the edge 302 to a desired design prior to folding over the edge. As illustrated in FIG. 9C, the sealed side edges 308 can extend to a bottom edge 307 of the fabric 300.

The tissue can be manufactured in an assembly line. For example, referring to FIG. 91, fabric 300 from, for example, a fabric supply roll, is trimmed to the desired shape at 312, here the shape of the tissue of FIG. 9H, and folded at 314. The sides 308 are cut and sealed at 316.

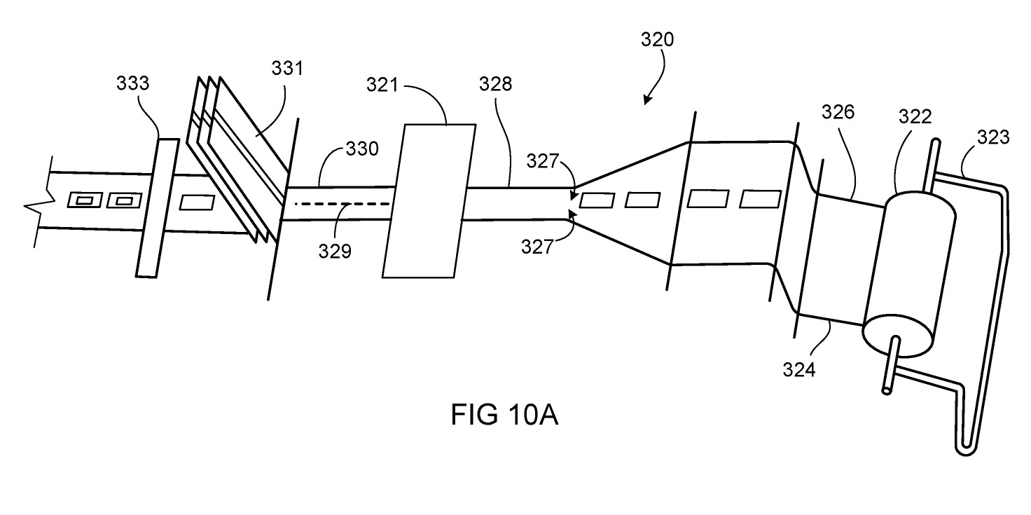

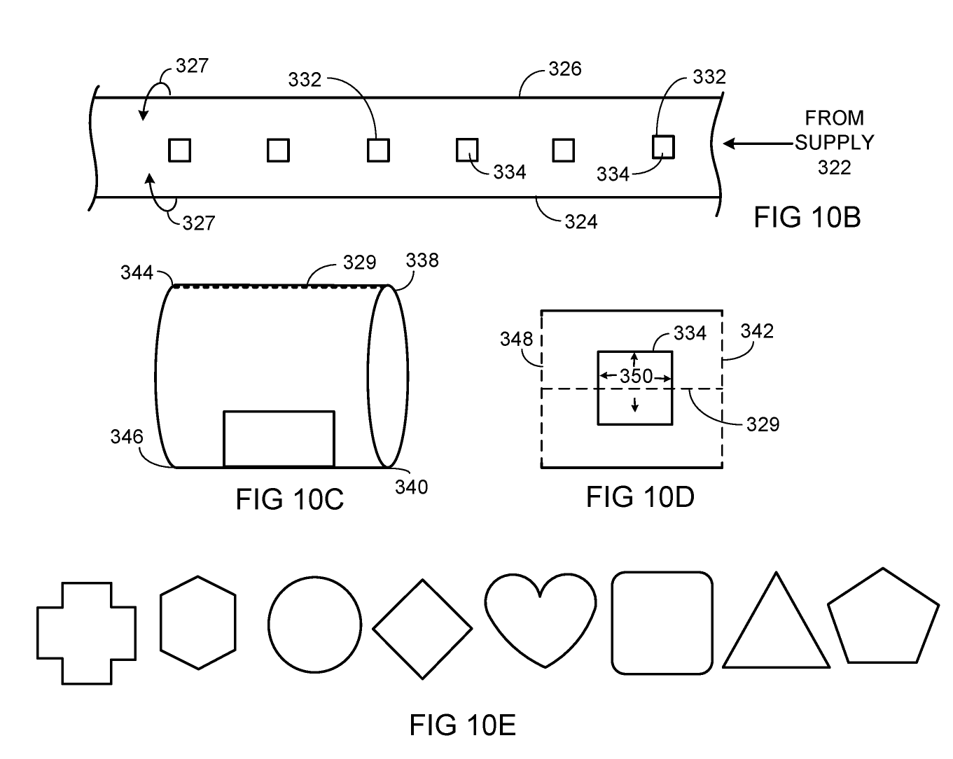

Alternatively, tissue can be formed using a fabric tube welding machine. Referring to FIG. 10A, a tube welding machine 320 pulls fabric from a roll of fabric supply 322 on an unwinder 323, folds the side edges 324, 326 of the fabric together (arrows 327) to form a tube shape 328, seals the side edges 324, 326 with a welding unit 321 to form a tube 330, and then flattens the tube at 331 and cuts the fabric to length to form the separate tissues while also sealing the cut edges with a cutting roller 333. Referring to FIGS. 10B-10D, to form the pocket(s) in the tissue, prior to forming the tube shape, shapes 332 are punched out in the fabric to create openings 334. The tube shape is then formed and the edges 324, 326 sealed to form sealed edge 329. The fabric is then cut and sealed such that opposing cut edges 338, 340 are sealed to form sealed edge 342, and opposing cut edges 344, 346 are sealed to form sealed edge 348. The final flattened product (FIG. 10D), has the opening 334 generally located in the center of the tissue forming four pockets 350. FIG. 10E illustrates examples of various shapes 332 that can be punched out in the fabric to create openings 334.

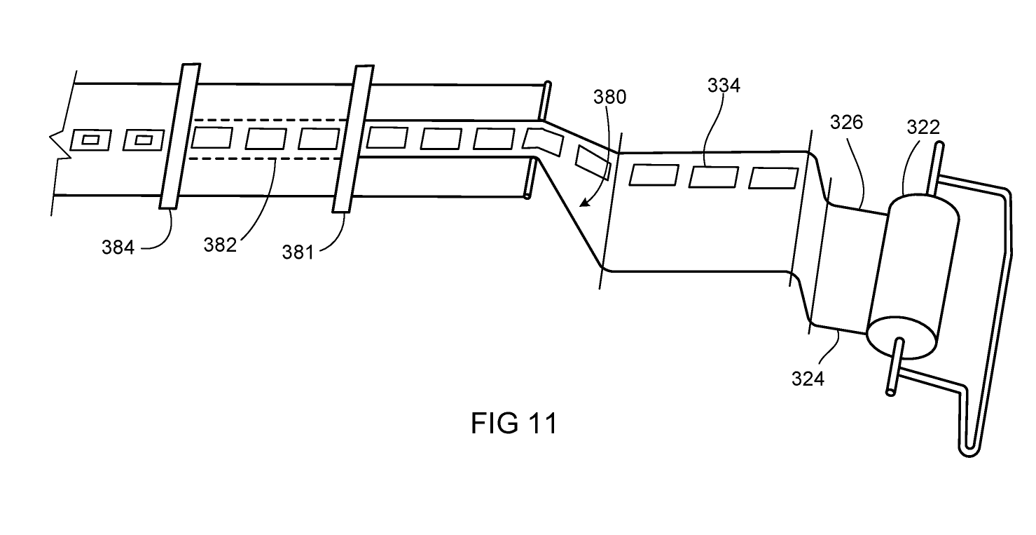

Referring to FIG. 11, in another alternative method of manufacturing the tissue, a fabric folding machine is used rather than a tube forming machine. Rather than punching an opening 334 along the middle of the fabric as seen in machine of Fig, 10A, the opening 334 is punched closer to the edge 326 or 324 of the fabric and then the fabric is folded along the midline (arrow 380). Edges 324 and 326 are sealed together at 381 created, for example, an ultrasonic rolling seam, to form sealed edge 382. The fabric is then cut and sealed at 384 to form the closed top end and the closed bottom end to form the final product. Alternatively, edges 324 and 326 can be sealed at 384. FIG. 10E illustrates examples of various shapes 332 that can be punched out in the fabric to create openings 334.

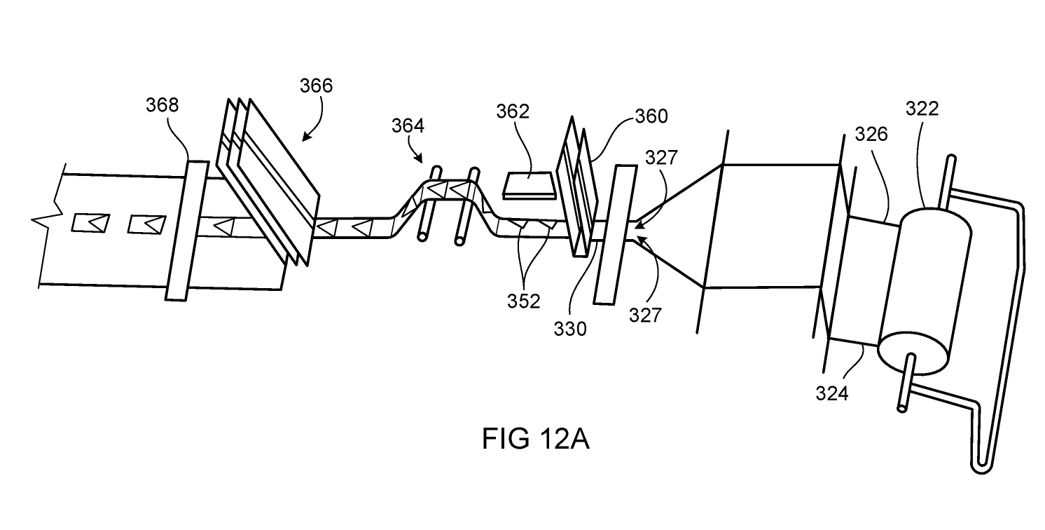

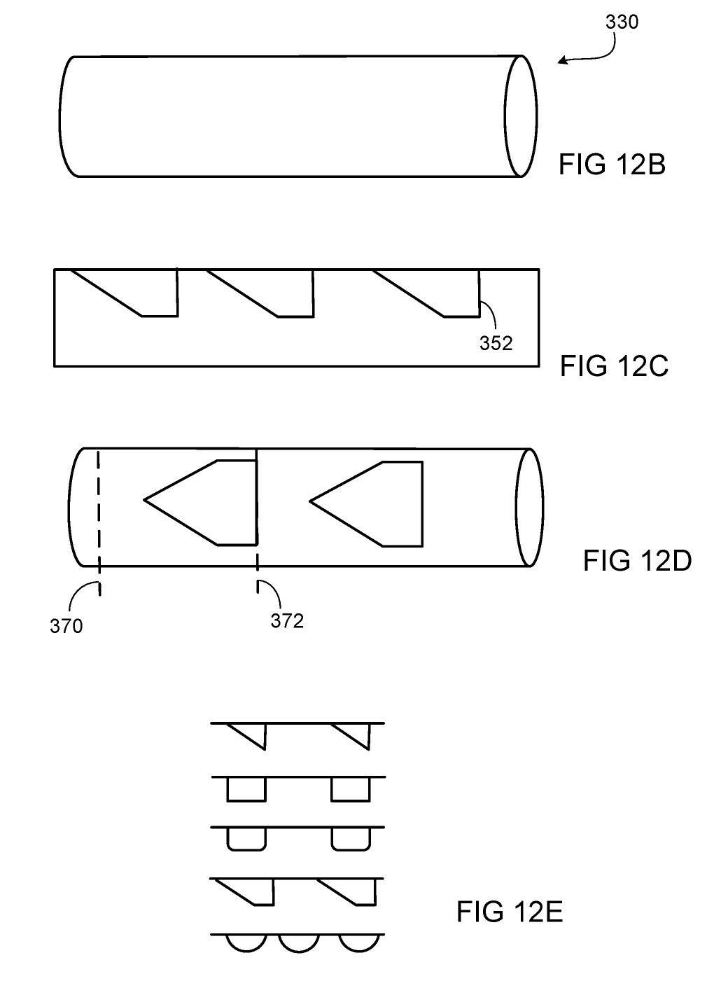

In an alternative method of manufacturing the tissue using the tube welding machine of FIG. 10A, rather than punching the fabric to create openings 334 before forming the tube, the fabric is cut after the sealed tube is formed. In particular, referring to FIGS. 12A-12D, the sealed tube is formed, the tube is flattened at 360, and a shape 352 is cut through one edge of the tube at 362 (a half-triangular shape cut is shown in FIG. 12A and a half-pentagon cut 352 is shown in FIG. 12C). The orientation of the plane of the fabric run is then changed at 364, rotating the tube 90 degrees such that when the re-orientated tube is again flattened at 366 for cutting and sealing, a full triangle or pentagon shape is formed, as illustrated in FIGS. 12A and 12D. The fabric is then cut and sealed to form top end sealed edge 370 and cut only at the bottom end 372 to form the final product of FIG. 9C (triangle cut) or the final product of FIG. 9D (pentagon cut). The next tissue in line can be cut and sealed at its top end 370 or the previous bottom end cut can just be sealed to form the top end of the next tissue. Referring to FIG. 12E, by modifying the shape of the cut 352 various configurations such as illustrated in FIGS. 9B and 9E-9H can be formed.

In general, the machine for making the tissue includes, for example, an unwinder for a fabric (material) supply roll, a tension belt to regulate tension of the fabric, a fabric puller, an optional ultrasonic welding unit for embossing, a material folding triangle board, an ultrasonic welding unit, a cutting roller, an optional final product folding unit, an optional final product stacking unit, and a conveyor. For punching openings, the machine includes, for example, an ultrasonic welding unit for shape hole sealing, a shape hole cutting roller, and an optional scrap export unit.

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

What is claimed is:

1. A method of using a hygienic tissue infused with liquid, comprising:
wiping a surface with the tissue, the tissue having a front side and a back side, the front side including an absorbent material, the tissue including a fluid resistant material behind the absorbent material and a pocket on the back side for receiving one or more of a user's fingers.

2-9. (canceled)

10. The method of claim 1 further comprising placing one or more fingers in the pocket.

11. The method of claim 1 further comprising accessing the pocket through an aperture defined by the back side.

12. The method of claim 11 wherein the aperture is surrounded on four sides by the back side such that pockets are formed along an entire circumference of the back side and the method includes placing fingers in the pockets.

13. The method of claim 1 wherein multiple pockets are formed on the back side and the method includes placing fingers in the pockets.

14. The method of claim 1 wherein wiping the surface with the tissue includes the back side of the tissue including an absorbent material and the fluid resistant material is between the front side absorbent material and the back side absorbent material.
